(19) United States
(12) Patent Application Publication
(10) Pub. No.: US 2006/0280252 A1
(43) Pub. Date: Dec. 14, 2006

(54) Method and apparatus for encoding video signal with improved compression efficiency using model switching in motion estimation of sub-pixel

(75) Inventors: Nyeong-kyu Kwon, Daejeon (KR); Hyun-ki Baik, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/452,278

(22) Filed: Jun. 14, 2006

Related U.S. Application Data
(60) Provisional application No. 60/690,131, filed on Jun. 14, 2005.

(30) Foreign Application Priority Data
Apr. 20, 2006 (KR) 10-2006-0035906

(51) Int. Cl. H04N 11/02; H04N 11/04; H04N 7/12; H04B 1/66

(52) U.S. Cl. 375/240.16; 375/240.24

(57) ABSTRACT

An encoding method and an encoding apparatus for increasing compression efficiency using model switching in motion estimation of a sub-pixel are provided. The encoding method includes obtaining a motion vector of a pixel existing on a block, generating a plurality of motion estimation models using a value of the motion vector, comparing estimation errors of the plurality of motion estimation models with one another, and selecting one motion estimation model which has a smaller estimation error according to the comparing of the estimation errors, and performing sub-pixel motion estimation using the selected motion estimation model.

### CROSS-REFERENCE TO RELATED APPLICATIONS

This application claims priority from Korean Patent Application No. 10-2006-0035906 filed on Apr. 20, 2006 in the Korean Intellectual Property Office, and U.S. Provisional Patent Application No. 60/690,131 filed on Jun. 14, 2005 in the United States Patent and Trademark Office, the disclosures of which are incorporated herein by reference in their entirety.

### BACKGROUND OF THE INVENTION

1. Field of the Invention

Apparatuses and methods consistent with the present invention relate to encoding a video signal, and more particularly, to encoding a video signal with improved compression efficiency using model switching in motion estimation of a sub-pixel.

2. Description of the Related Art

In video compression techniques, in order to compress a macroblock of a current frame utilizing temporal similarity of adjacent frames, the most similar areas are searched for among previous frames. This process is called a motion estimation process. Among the previous frames associated with the motion estimation process, vectors pointing to the most similar areas obtained through the motion estimation process are called motion vectors. To determine regional similarity between a block of the current picture and an adjacent block, a difference between regions, called a block matching error, is measured. In measuring the block matching error, a variety of techniques are used, including a sum of absolute difference (SAD) technique, a mean of absolute difference technique (MAD), a mean of square error (MSE) technique, and so on. As the difference between two blocks becomes smaller, the two blocks are considered as being more similar.

Meanwhile, to increase video compression efficiency, motion vectors in units of sub-pixels such as half pixels or quarter pixels are used. FIG. 1 shows a half pixel calculation method for each integer pixel.

FIG. 1 illustrates conventional integer pixels and half pixels. A half pixel (e, f, g, h) can be obtained using an integer pixel (A, B, C, D) according to Equation 1 given below as:
e=A
f=(A+B+1)/2
g=(A+C+1)/2
h=(A+B+C+D+2)/4 [Equation 1]

Half pixel values can be estimated through values of neighboring integer pixels, and quarter pixel values can be estimated by searching values of neighboring half pixels or neighboring integer pixels. As the accuracy of a half pixel motion vector or a quarter pixel motion vector increases, a number of search points required for motion estimation increases. Accordingly, a computational amount sharply increases.

To address this, there have been proposed model-based sub-pixel motion vector estimation techniques, in which an error between neighboring points corresponding to a sub-pixel motion vector is calculated using models for blocks corresponding to integer pixel motion vectors without computing the block error of the sub-pixel motion vector.

Such model-based sub-pixel motion vector estimation techniques, however, exhibit different accuracy depending on the compressed video. Thus, an appropriate model should be used for achieve higher compression efficiency. Since an error between models differs according to video signal characteristics, use of a single model involves a limitation. In order to increase the compression efficiency, therefore, it is necessary to use a model with a higher accuracy.

### SUMMARY OF THE INVENTION

The present invention provides a method and an apparatus for encoding a video signal with improved compression efficiency by selecting one among a plurality of models to be used in sub-pixel motion estimation.

The present invention also provides a method and apparatus for increasing a bit rate by adaptively selecting a model according to video signal characteristics.

The above stated aspects as well as other aspects of the present invention will become clear to those skilled in the art upon review of the following description.

According to an aspect off the present invention, there is provided an encoding method for increasing compression efficiency using model switching in motion estimation of a sub-pixel, the encoding method including obtaining a motion vector of a pixel existing on a block, generating a plurality of motion estimation models using a value of the motion vector, comparing estimation errors of the plurality of motion estimation models with one another, and selecting one of the plurality of motion estimation models according to the comparing of the estimation errors, and performing sub-pixel motion estimation using the selected motion estimation model.

According to another aspect of the present invention, there is provided an encoder for increasing compression efficiency using model switching in motion estimation of a sub-pixel, the encoder including a pixel calculator obtaining a motion vector of a pixel existing on a block, a model calculator generating a plurality of motion estimation models using a value of the motion vector obtained from the pixel calculator, a model selector comparing estimation errors of the plurality of motion estimation models with one another, and selecting one of the plurality of motion estimation models according to the comparing of the estimation errors, and a motion estimator performing sub-pixel motion estimation using the selected motion estimation model.

### BRIEF DESCRIPTION OF THE DRAWINGS

The above and other features and advantages of the present invention will become more apparent by describing in detail preferred embodiments thereof with reference to the attached drawings, in which:

FIG. 1 illustrates conventional integer pixel and half pixel;

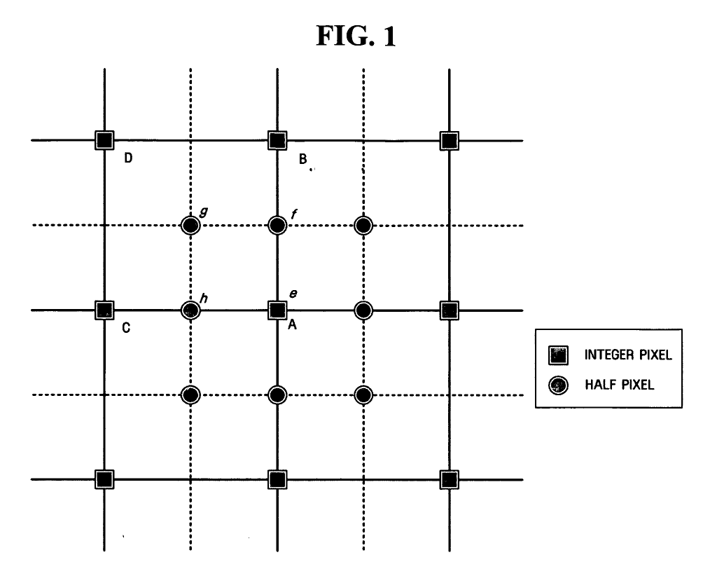

FIGS. 2A and 2B illustrate exemplary models used for half-pixel or quarter-pixel motion estimation using an integer pixel;

FIG. 3 is a flowchart showing an example of a process of calculating a motion vector of a sub-pixel using estimation models according to an exemplary embodiment of the present invention;

FIG. 4 is a block diagram showing a video encoder according to an exemplary embodiment of the present invention;

FIG. 5 illustrates a linear (LIN) model and a quadratic (QUAD) model obtained by calculating integer pixel motion vectors according to an exemplary embodiment of the present invention; and

FIG. 6 illustrates improved compression performance of videos depending on bit rates according to an exemplary embodiment of the present invention.

### DETAILED DESCRIPTION OF EXEMPLARY EMBODIMENTS OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention is described hereinafter with reference to flowchart illustrations of methods according to exemplary embodiments of the invention. It will be understood that each block of the flowchart illustrations and combinations of blocks in the flowchart illustrations can be implemented by computer program instructions. These computer program instructions can be provided to a processor of a general purpose computer, special purpose computer or other programmable data processing apparatuses to produce a machine, such that the instructions, which execute via the processor of the computer or other programmable data processing apparatuses, create means for implementing the functions specified in the flowchart block or blocks. These computer program instructions may also be stored in a computer usable or computer-readable memory that can direct a computer or other programmable data processing apparatuses to function in a particular manner such that the instructions stored in the computer usable or computer-readable memory produce an article of manufacture including instruction means that implement the function specified in the flowchart block or blocks. The computer program instructions may also be downloaded into a computer or other programmable data processing apparatuses, causing a series of operational steps to be performed on the computer or other programmable apparatuses to produce a computer implemented process such that the instructions that execute on the computer or other programmable apparatuses provide steps for implementing the functions specified in the flowchart block or blocks.

Each block of the flowchart illustrations may represent a module, segment or portion of code, which comprises one or more executable instructions for implementing the specified logical function(s). It should also be noted that in some alternative implementations the functions noted in the blocks may occur out of order. For example, two blocks shown in succession may in fact be executed almost concurrently or the blocks may sometimes be executed in reverse order, depending upon the functionality involved.

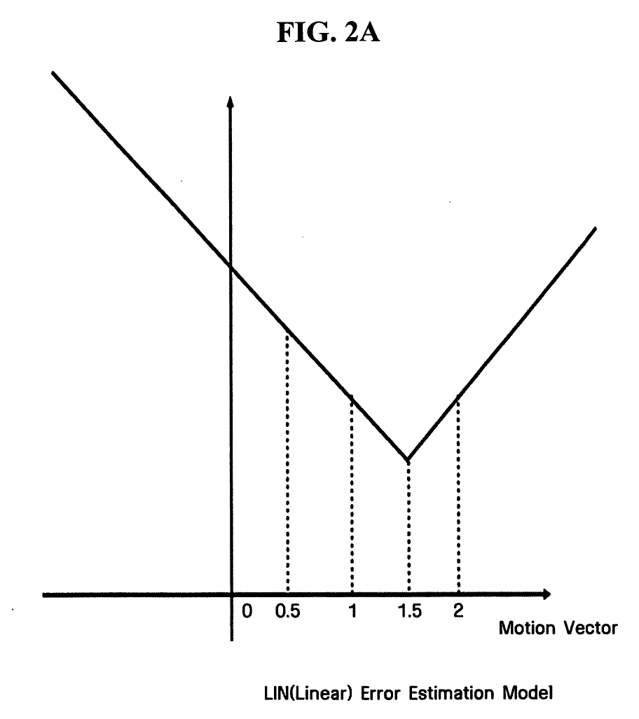

FIGS. 2A and 2B illustrate exemplary models used for half-pixel or quarter-pixel motion estimation using an integer pixel.

A linear (LIN) model shown in FIG. 2A is a model used to estimate an error between sub-pixels using a linear (LIN) equation model provided in Equation 2:
ε(x)=a|x−b|+c, a>0, |b|<0.5, c>0, [Equation 2]

whereas a quadratic model shown in FIG. 2B is a model used to estimate an error between sub-pixels using a second-order or quadratic (QUAD) equation model provided in Equation 3:
ε(x)=ax²+bx+c, (a>0). [Equation 3]

Since the model-based estimation method shown in FIG. 2A or 2B has a different accuracy depending on a compressed video, it is necessary to adaptively employ an appropriate model to achieve higher compression efficiency. For example, FIG. 2A illustrates a motion vector 1.5 estimated as an optimal value, while FIG. 2B illustrates a motion vector 1.0 estimated as an optimal value. At this time, if an error value of each model is estimated, it would be possible to increase the compression efficiency using a model having a higher accuracy.

To calculate a motion vector of a half pixel, error criterion values at the half pixel can be measured by interpolating error criterion values of a full pixel (integer pixel). Since a motion vector generally exists in horizontal and vertical directions, motion vector estimation can be performed in both directions.

For example, the LIN interpolation model or QUAD model shown in FIGS. 2A and 2B may be used. While it is possible to keep track of such estimation models mathematically, the compression efficiency thereof may differ depending on coding conditions. Referring to FIGS. 2A and 2B, the models can be implemented based on values of 0, 1, and 2. Accordingly, the estimation model values are encoded to then be transmitted to a decoder.

When a value of a sub-pixel such as a half pixel or a quarter-pixel is calculated using the model, the sub-pixel accuracy may depend upon the model selected. In addition, since the accuracy depends upon input data as well, it is quite important which model to select.

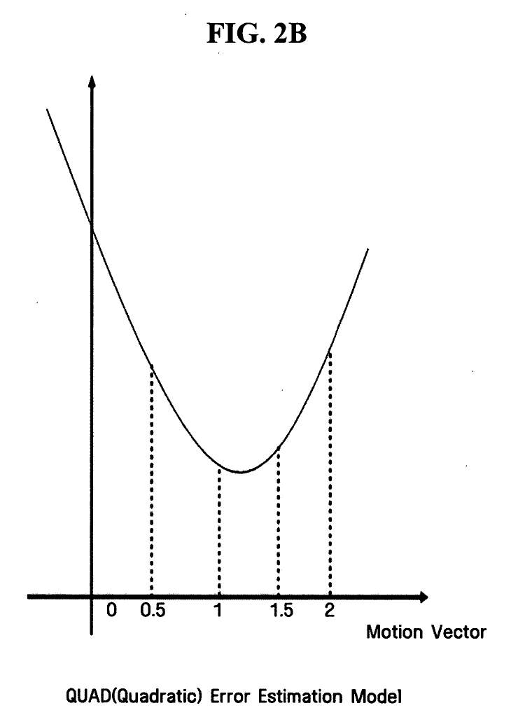

Therefore, as shown in FIG. 3, in order to search for a sub-pixel motion vector, model switching is adaptively performed. Then, the sub-pixel motion vector obtained from a higher accuracy model is encoded.

FIG. 3 is a flowchart showing an example of a process of calculating a sub-pixel motion vector using estimation models according to an exemplary embodiment of the present invention.

In operation S310, motion vectors of reference pixels are obtained. For example, in case of obtaining a motion vector of a half pixel, motion vectors of surrounding integer pixels as reference pixels are obtained. In case of obtaining a motion vector of a quarter-pixel, motion vectors of surrounding half pixels or integer pixels as reference pixels are obtained. Since a motion vector can be represented by x- and y-direction components, the procedure shown in FIG. 3 can be applied to x and y, respectively.

In operation S320, estimation models, i.e., first and second models, are generated using x and y values, i.e., the obtained motion vectors of the reference pixels. The estimation models may be an LIN model and a QUAD model, as shown in FIG. 2. To generate the estimation models, the equations for the respective models can be applied using x and y vector values of integer pixels that can be indexed.

The estimation models can be used in a wide variety of manners and two or more estimation models can be generated. Meanwhile, even a single estimation model may be regarded as independent two estimation models if it generates slightly different two or more models by being set with two or more parameters.

After generating two or more models, sub-pixel motion vectors to be searched in the respective models are estimated. Referring to graphs shown in FIGS, 2A and 2B, an error for motion vectors 0.5 and 1.5 can be computed using the integer pixel motion vectors of 0, 1, and 2. Then, an estimation error of the first model and an estimation error of the second model are compared with each other in operation S330. In operation S340, it is determined whether the estimation error of the first model is smaller than the estimation error of the second model or not. If it is determined that the estimation error of the first model is smaller than the estimation error of the second model, suggesting that the first model has higher accuracy, the first model is selected in performing sub-pixel motion estimation in operation S350.

If it is determined that the estimation error of the first model is greater than the estimation error of the second model, suggesting that the second model has higher accuracy, the second model is selected in performing sub-pixel motion estimation in operation S360.

The determination of model selection may be done for each sub-pixel, macroblock, or subblock. However, if the determination of model selection is often done to increase the accuracy, a computation amount may unduly increase. Accordingly, the optimal trade-off of encoding conditions is dependent on the computation amount and the accuracy.

In FIG. 3, an exemplary process of the model is described. For example, processing or generating model means calculating parameter of Equation 2 and Equation 3, and obtaining an applicable equation according to the given x value. So, it needs to calculate parameters a, b, and c in Equation 2 and Equation 3.

First, the LIN model can be implemented according to Equation 2. In Equation 2, x represents a value of 0, 1, or −1, and MAD error values ε(−1), ε(0), and ε(1) at integer locations can be expressed in Equation 4:
ε(−1)=a+ab+c
ε(0)=ab+c, if b<0; and
−ab+c, otherwise
ε(1)=a−a−ab+c [Equation 4]

Vector E, X, and A is necessary to calculate a, b and c. These vectors are defined in Equation 5 below. The vector E is represented with the MAD error value having x values of −1, 0 and 1, and the vector X is represented with a matrix of parameters of a, ab, and c. The relationship of the matrix can be expressed by E=XA.

$$\begin{matrix}E = [ ɛ ( - 1 ) ɛ ( 0 ) ɛ ( 1 ) ] \\ X = [ \begin{matrix}1 & 1 & 1 \\ 0 & 1 & 1 \\ 1 & - 1 & 1\end{matrix} ] \\ A = [ a ab c ]\end{matrix} \qquad [ Equation 5 ]$$

To deduce the Equation 2, the vector matrix can be written by Equation 6:

[Equation 6]

$$A = {X}^{- 1} E = INV ( X ) E \\ = [ \begin{matrix}1 & - 1 & 0 \\ \frac{1}{2} & 0 & - \frac{1}{2} \\ \frac{1}{2} & 1 & \frac{1}{2}\end{matrix} ] [ \begin{matrix}ɛ ( - 1 ) \\ ɛ ( 0 ) \\ ɛ ( 1 )\end{matrix} ] , if b < 0 \\ [ \begin{matrix}0 & - 1 & 1 \\ \frac{1}{2} & 0 & \frac{1}{2} \\ \frac{1}{2} & 1 & - \frac{1}{2}\end{matrix} ] [ \begin{matrix}ɛ ( - 1 ) \\ ɛ ( 0 ) \\ ɛ ( 1 )\end{matrix} ] , otherwise \qquad [ Equation 6 ]$$

The model parameters can be obtained according to Equation 7:

$$if b < 0 , \\ a = ɛ ( - 1 ) - ɛ ( 0 ) \\ b = \{ \frac{1}{2} ɛ ( - 1 ) - \frac{1}{2} ɛ ( ( 1 ) \} / a \\ c = \frac{1}{2} ɛ ( - 1 ) + ɛ ( 0 ) + \frac{1}{2} ɛ ( ( 1 ) \\ otherwise \\ a = - ɛ ( 0 ) + ɛ ( 1 ) \\ b = \{ \frac{1}{2} ɛ ( - 1 ) - \frac{1}{2} ɛ ( ( 1 ) \} / a \\ c = \frac{1}{2} ɛ ( - 1 ) + ɛ ( 0 ) - \frac{1}{2} ɛ ( ( 1 ) \qquad [ Equation 7 ]$$

Since the values of a, b and c are computed using Equation 7, the LIN model can be generated. Further, error values at other locations, for example, ε(−2) and ε(2), can also be calculated using the LIN model according to Equation 8:
ε(−2)=2a+ab+c
ε(2)=2a−ab+c [Equation 8]

The QUAD model can be obtained in a manner similar to the above-described process. That is to say, error values at integer locations can be obtained by applying −1, 0 and 1 to the x value in Equation 3, as given by Equation 9:
ε(−1)=a−b+c
ε(0)=c
ε(1)=a+b+c [Equation 9]

The vectors E, X and A given in Equation 5 are defined in Equation 10:

$$\begin{matrix}E = [ ɛ ( - 1 ) ɛ ( 0 ) ɛ ( 1 ) ] \\ X = [ \begin{matrix}1 & - 1 & 1 \\ 0 & 0 & 1 \\ 1 & 1 & 1\end{matrix} ] \\ A = [ a b c ]\end{matrix} \qquad [ Equation 10 ]$$

To deduce the Equation 3, the vector matrix can be written by Equation 11:

$$A = {X}^{- 1} E = INV ( X ) E \\ = [ \begin{matrix}\frac{1}{2} & - 1 & \frac{1}{2} \\ - \frac{1}{2} & 0 & \frac{1}{2} \\ 0 & 1 & 0\end{matrix} ] [ \begin{matrix}ɛ ( - 1 ) \\ ɛ ( 0 ) \\ ɛ ( 1 )\end{matrix} ] . \qquad [ Equation 11 ]$$

The model parameters can be obtained according to Equation 12 below:

$$a = \frac{1}{2} ɛ ( - 1 ) - ɛ ( 0 ) + \frac{1}{2} ɛ ( 1 ) \\ b = - \frac{1}{2} ɛ ( - 1 ) + \frac{1}{2} ɛ ( ( 1 ) \\ c = ɛ ( 0 ) \qquad [ Equation 12 ]$$

The computed values of a, b and c are used in obtaining the QUAD model represented in Equation 3 and the error values at other locations, for example, ε(−2) and ε(2), can also be generated using the QUAD model according to Equation 13 below:
ε(−2)=4a−2b+c
ε(2)=4a+2b+c [Equation 13]

The above-described processes are provided as only exemplary embodiments for obtaining an LIN model and a QUAD model, and changes or modifications of the process may be made according to the model used.

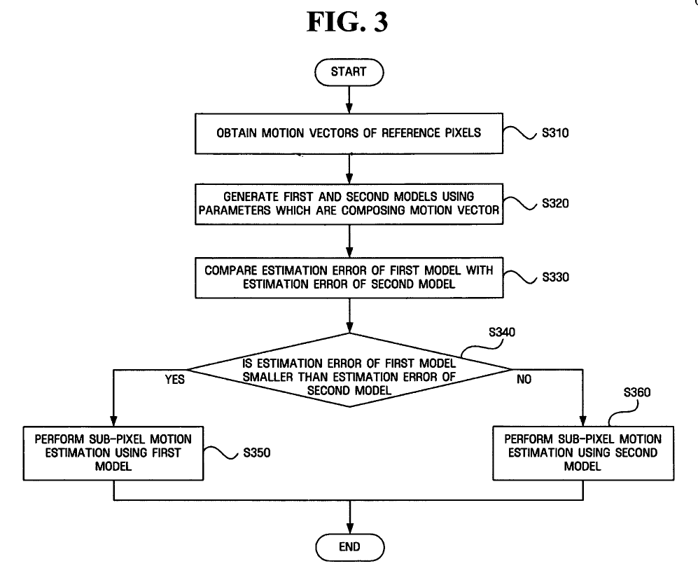

FIG. 4 is a block diagram showing a video encoder 400 according to an embodiment of the present invention.

The video encoder 400 shown in FIG. 4 performing encoding and quantization on a video signal and a detailed explanation of the configuration thereof will not be given. The video encoder 400 is constituted by an integer pixel calculator 410 as an exemplary pixel calculator calculating motion vectors of pixels existing in a block, a plurality of model calculators 421, 422, . . . , and 429 calculating models using motion vector values of the integer pixel calculator 410, a model selector 430 comparing an estimation error between each of the models calculated by the model calculators 421, 422, . . . , and 429 and selecting a model having a smaller estimation error, and a motion estimator 450 performing motion estimation according to the selected model.

The integer pixel calculator 410 calculates a motion vector of an integer pixel from an input video signal. Then, the motion vector of the integer pixel is used to estimate a sub-pixel motion vector. Of course, the integer pixel calculator 410 also calculates a motion vector of a half pixel and generates data used to estimate a quarter pixel motion vector according to the type of a sub-pixel. That is to say, the integer pixel calculator 410 is an example of an integer pixel calculator providing data necessary for estimating a smaller unit sub-pixel motion vector.

The first model calculator 421, the second model calculator 422, and the N-th model calculator 429 generate estimation models using the calculation result from the integer pixel calculator 410. In addition, the first model calculator 421, the second model calculator 422, and the N-th model calculator 429 calculate errors of half pixels to be obtained using the estimation models. Each model calculator may be independently implemented by model within an encoder. Also, there may be a model calculator capable of calculating a plurality of models using input integer pixel information.

The model selector 430 compares errors between each of motion vectors from the calculated plurality of models with one another and selects a model having the smallest error. The selected model having the smallest error is to be used later when encoding a half pixel or quarter pixel motion vector.

The motion estimator 450 estimates a motion vector of a sub-pixel such as a half pixel or a quarter pixel according to the selected model. The motion estimator 450 may perform motion estimation by frame, macroblock, or subblock, according to the selected model.

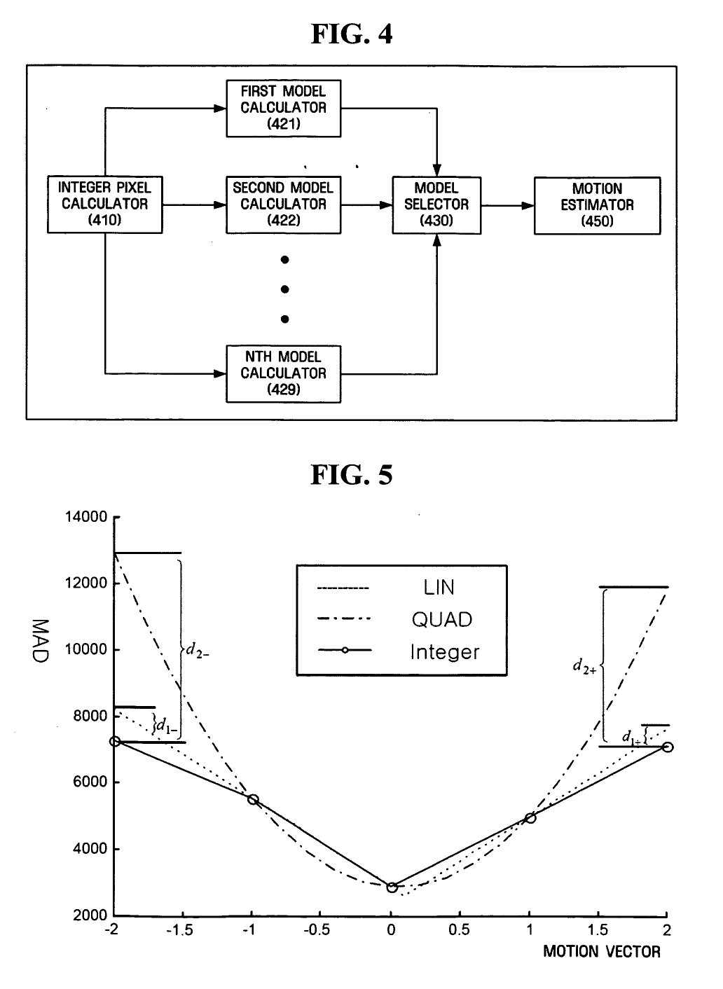

FIG. 5 illustrates a linear (LIN) model and a quadratic (QUAD) model obtained by calculating integer pixel motion vectors according to an exemplary embodiment of the present invention. In an exemplary embodiment of the present invention, one of two models having a smaller error may be selected. dₘ indicates a difference between an estimated value and a calculated value through the integer pixel search of the actual model, and m indicates each model. Here, the condition m ε{1=LIN, 2=QUAD} is satisfied.

As shown in FIG. 5, differences dₘ, dₘ₋, and dₘ₊ can be expressed in Equation 14 below:

$$\begin{matrix}{d}_{m} = abs ( {d}_{m -} ) + abs ( {d}_{m +} ) \\ = \vert y ( - 2 ) - \overline{y} ( - 2 ) \vert + \vert y ( 2 ) - \overline{y} ( 2 ) \vert\end{matrix} \qquad [ Equation 14 ]$$

Model switching can be expressed as Equation 15:

$$m = {arg}_{m ∈ \{ 1 = LIN , 2 = QUAD \}} min ( {d}_{m} ) \qquad [ Equation 15 ]$$

A model having the smallest difference is selected at the current location and an estimation process is then performed.

In addition to the LIN and QUAD models, any one among a variety of models that has the smallest difference can be used for motion estimation. Furthermore, motion estimation can be performed over processing time by frame, macroblock, or subblock.

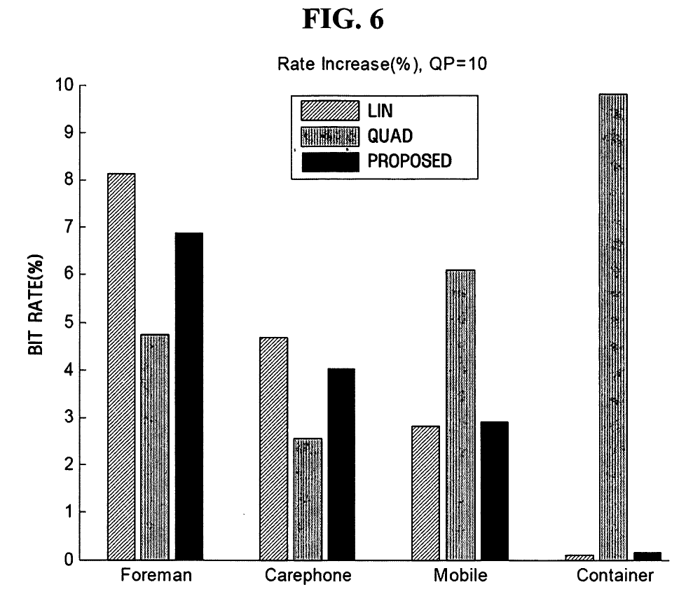

FIG. 6 illustrates improved compression performance of videos depending on bit rates according to an exemplary embodiment of the present invention. Referring to FIG. 6, video data have different bit rates for each of the LIN model and the QUAD model, respectively. For example, while a foreman video and a carephone video exhibit a higher bit rate in a case when using the LIN model compared to a case when using the QUAD model, a mobile video and a container video exhibit a higher bit rate in a case when using the QUAD model compared to a case when using the LIN model. Therefore, according to the exemplary embodiments of the present invention, a constant bit rate can be maintained.

As described above, the present invention provides for an apparatus and a method for encoding a video signal by selecting one among a plurality of models for estimating a sub-pixel motion vector.

In addition, the present invention allows a model to be adaptively selected according to characteristics of a video signal, thereby increasing compression efficiency.

Although an exemplary embodiments of the present invention have been shown and described, the present invention is not limited to the described embodiment. Instead, it would be appreciated by those skilled in the art that changes may be made to the embodiment without departing from the principles and spirit of the invention, the scope of which is defined by the claims and their equivalents.

What is claimed is:

1. An encoding method using model switching in motion estimation of a sub-pixel, the encoding method comprising:
obtaining a motion vector of a pixel existing on a block;
generating a plurality of motion estimation models using a value of the motion vector;
comparing estimation errors of the plurality of motion estimation models with one another; and
selecting one of the plurality of motion estimation models according to the comparing of the estimation errors and performing sub-pixel motion estimation using the selected motion estimation model.

2. The encoding method of claim 1, wherein the selected motion estimation model has a smallest estimation error among the plurality of motion estimation models.

3. The encoding method of claim 1, wherein the block is a macroblock or a subblock.

4. The encoding method of claim 1, wherein the plurality of motion estimation models comprise at least one of a linear (LIN) model and a quadratic (QUAD) model.

5. The encoding method of claim 1, wherein when the pixel is an integer pixel, the sub-pixel is a half pixel or a quarter pixel.

6. The encoding method of claim 1, wherein when the pixel is a half pixel, the sub-pixel is a quarter pixel.

7. An encoder using model switching in motion estimation of a sub-pixel, the encoder comprising:
a pixel calculator which obtains a motion vector of a pixel existing on a block;
a model calculator which generates a plurality of motion estimation models using a value of the motion vector obtained from the pixel calculator;
a model selector which compares estimation errors of the plurality of motion estimation models with one another, and selects one of the plurality of motion estimation models according to the comparison of the estimation errors; and
a motion estimator which performs sub-pixel motion estimation using the selected motion estimation model.

8. The encoder of claim 7, wherein the selected motion estimation model has a smallest estimation error among the plurality of motion estimation models.

9. The encoder of claim 7, wherein the block is a macroblock or a subblock.

10. The encoder of claim 7, wherein the plurality of motion estimation model comprise at least one of a linear (LIN) model and a quadratic (QUAD) model.

11. The encoder of claim 7, wherein when the pixel is an integer pixel, the sub-pixel is a half pixel or a quarter pixel.

12. The encoder of claim 7, wherein when the pixel is a half pixel, the sub-pixel is a quarter pixel.
